(19) United States
(12) Patent Application Publication
(10) Pub. No.: US 2026/0003418 A1
(43) Pub. Date: Jan. 1, 2026

(54) DYNAMIC POWER PROFILE ADJUSTMENT

(71) Applicant: Micron Technology, Inc., Boise, ID (US)

(72) Inventor: Yikai Hu, Shanghai (CN)

(21) Appl. No.: 19/221,184

(22) Filed: May 28, 2025

Related U.S. Application Data
(60) Provisional application No. 63/666,001, filed on Jun. 28, 2024.

(51) Int. Cl. G06F 1/3234

(52) U.S. Cl. CPC G06F 1/3234

(57) ABSTRACT

Methods, systems, and devices for dynamic power profile adjustment are described. A memory system may determine a power profile to use for memory operations in response to detecting a change in a data rate associated with a host system. For example, if the data rate satisfies a threshold data rate, the memory system may switch from a first power profile to a second power profile. Switching power profiles may include switching from a first set of clock settings to a second set of clock settings. In some cases, the change in data rate may occur within a period, which may follow a coupling of the memory system and the host system. If the memory system switches to the second power profile, the memory system may remain operating in the second power profile until a next power profile determination event.

### CROSS REFERENCE

The present Application for Patent claims priority to U.S. Patent Application No. 63/666,001 by Hu, entitled “DYNAMIC POWER PROFILE ADJUSTMENT,” filed Jun. 28, 2024, which is assigned to the assignee hereof, and which is expressly incorporated by reference in its entirety herein.

### TECHNICAL FIELD

The following relates to one or more systems for memory, including dynamic power profile adjustment.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports dynamic power profile adjustment in accordance with examples as disclosed herein.

FIG. 2 shows an example of a flow diagram that supports dynamic power profile adjustment in accordance with examples as disclosed herein.

FIG. 3 shows a block diagram of a memory system that supports dynamic power profile adjustment in accordance with examples as disclosed herein.

FIG. 4 shows a flowchart illustrating a method or methods that support dynamic power profile adjustment in accordance with examples as disclosed herein.

### DETAILED DESCRIPTION

A memory system may support operations according to commands from one or more different types of host systems according to one or more different operation protocols. In some examples, a memory system may be configured to support multiple types of host systems each associated with different power profiles for the memory system. For example, a memory system may support operations (e.g., access operations and other commands from a host system) according to multiple universal flash storage (UFS) protocols, including UFS3 or UFS4, among other examples of operation protocols. Different operation protocols may be associated with different types of commands and access operations for the memory system. As such, a memory system may operate according to multiple different power profiles (e.g., different peak power limits, different performance targets) in accordance with a type of operation profile of a host system in communication with the memory system.

A power profile may indicate (e.g., include, define, or otherwise be associated with) one or more clock settings (e.g., tables of clock parameters) for memory operations (e.g., read, write, data transfer) of the memory system. In some cases, each operation protocol supported by a memory system may correspond to a different set of one or more clock settings, and each clock setting may include at least one parameter for one or more clocks associated with the memory system. In some cases, while operating according to a power profile, the memory system may select a clock setting from the power profile according to one or more operating parameters at the memory system (e.g., temperature, received operating commands, a degradation level of the memory system, or the like). Additionally, or alternatively, each operation protocol may be associated with a respective set of one or more data rates (e.g., gears), where some operation protocols (e.g., USF4) may operate in higher data rates than other operation protocols (e.g., UFS3). Some memory systems may operate according to a fixed operation protocol and power profile, which may be different than an operation protocol of a host system coupled with the memory system. Mismatched operation protocols (e.g., and power profiles) between the memory system and the host system may lead to one or more issues at the memory system, including exceeding or failing to reach a performance target of the host operation protocol, or mismatched clock settings between the host system and the memory system, among other examples.

According to techniques described herein, to provide for a memory system to accurately detect an operation protocol used by a host system and adjust the memory system power consumption accordingly, the memory system may monitor data rates associated with operations requested by the host system, and may adjust power profiles in response to the data rates. For example, the memory system may determine a power profile (e.g., an operation protocol) to use for memory operations at the memory system in response to detecting a change in a data rate associated with the memory system. If the data rate satisfies (e.g., exceeds) a threshold data rate, the memory system may switch from a first power profile (e.g., associated with a first operation protocol, such as UFS3) to a second power profile (e.g., associated with a second operation protocol, such as UFS4). Switching power profiles may include switching from a first set of clock settings (e.g., clock parameter tables) associated with the first power profile to a second set of clock settings associated with the second power profile.

In some cases, the memory system may communicate (e.g., exchange signaling) with a host system according to a first data rate (e.g., a default data rate) during a first period of operation. The first period of operation may include a power-on duration or an initialization period, which may follow (e.g., occur in response to) a coupling of the memory system and the host system. The memory system may operate according to the first data rate until the memory system detects a change in data rate or some other switching condition. After the memory system switches to the second power profile in response to detecting the change in the data rate, the memory system may remain operating in the second power profile indefinitely or until a next power profile determination event (e.g., a subsequent power-on duration, an initialization period, a reset, another coupling event).

In addition to applicability in memory systems as described herein, techniques for dynamic power profile adjustment may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving data rates between a host system and a memory system, which may decrease processing or latency times, improve response times, or otherwise improve user experience, among other benefits.

Features of the disclosure are illustrated and described in the context of systems, devices, and circuits. Features of the disclosure are further illustrated and described in the context of processes and flowcharts.

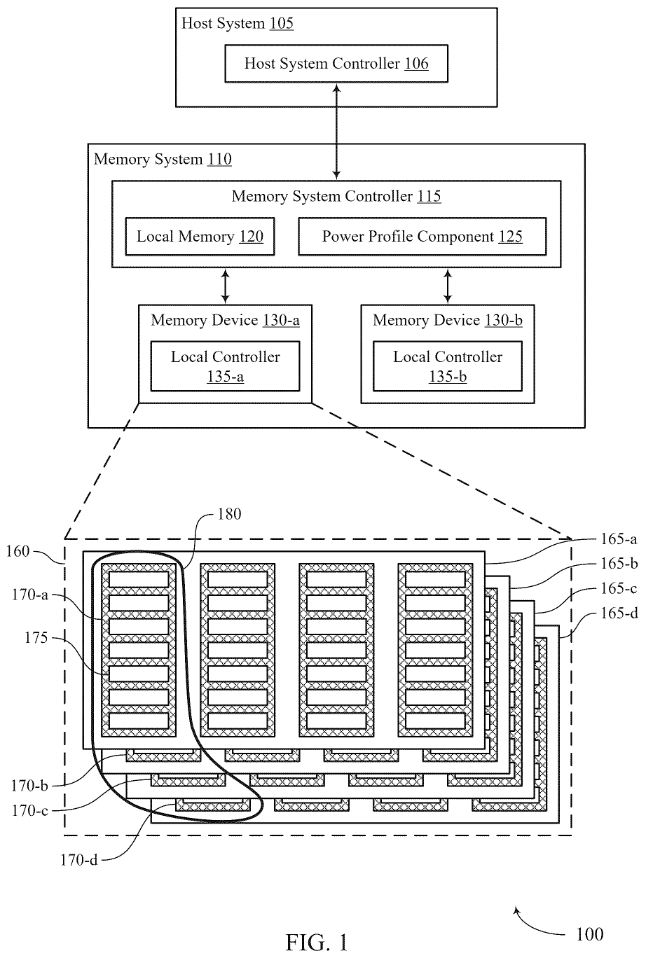

FIG. 1 shows an example of a system 100 that supports dynamic power profile adjustment in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some cases, the host system 105 and the memory system 110 may operate according to respective operation protocols of a plurality of operation protocols (e.g., including UFS3 and UFS4, among other examples). For example, each operation protocol (e.g., UFS3, USF4) may be associated with a different set of data rates (e.g., a different gear), a different power profile, a different peak power limit, a different performance target, or any combination thereof. For example, UFS3 may be associated with one set of data rates (e.g., gear 4, two gigabytes (GB) per second (GB/sec)) and UFS4 may be associated with another set of data rates (e.g., gear 5, four GB/sec). A gear may be another term for a set of data rates.

According to techniques described herein, the memory system 110 may determine a power profile (e.g., a UFS protocol) to use for memory operations at the memory system 110 in response to detecting a change in a data rate associated with the memory system 110. In some cases, the memory system 110 may include one or more power profile components 125, which may operate the memory system according to a power profile, detect the change in the data rate, cause the memory system 110 to operate according to the second power profile, or any combination thereof. In some examples, if the data rate (e.g., the changed data rate, a second data rate different from an initial data rate) satisfies (e.g., exceeds) a threshold data rate, the memory system may switch from a first power profile (e.g., an initial power profile, associated with a first UFS protocol, UFS3) to a second power profile (e.g., associated with a second UFS protocol, UFS4) that is different from the first power profile.

Switching power profiles may include switching from a first set of clock settings associated with the first power profile to a second set of clock settings associated with the second power profile. In some cases, the memory system may detect the change to the data rate during a period, where the period may include a power-on duration or an initialization period, which may occur in response to coupling of the memory system 110 and the host system 105. Additionally, or alternatively, after the memory system 110 switches to the second power profile in response to the change in the data rate, the memory system 110 may remain operating in the second power profile until a next power profile determination event (e.g., a power-on period, an initialization period, a reset).

In some cases, the memory system 110 may include a plurality of memory devices 130. In some cases, each memory device 130 may operate according to a respective power profile (e.g., according to a respective UFS protocol). For example, the power profile component 125 may detect a change in a first data rate associated with the memory device 130-a, such that the first data rate may satisfy the threshold data rate. Additionally, or alternatively, the power profile component 125 may not detect a change in a second data rate associated with the memory device 130-b (e.g., or detect a relatively small change in the second data rate), such that the second data rate may not satisfy the threshold data rate. In such cases, the memory device 130-a may operate according to a second power profile (e.g., according to the USF4), and the memory device 130-b may operate according to the first power profile (e.g., according to USF3).

The system 100 may include any quantity of non-transitory computer readable media that support dynamic power profile adjustment. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

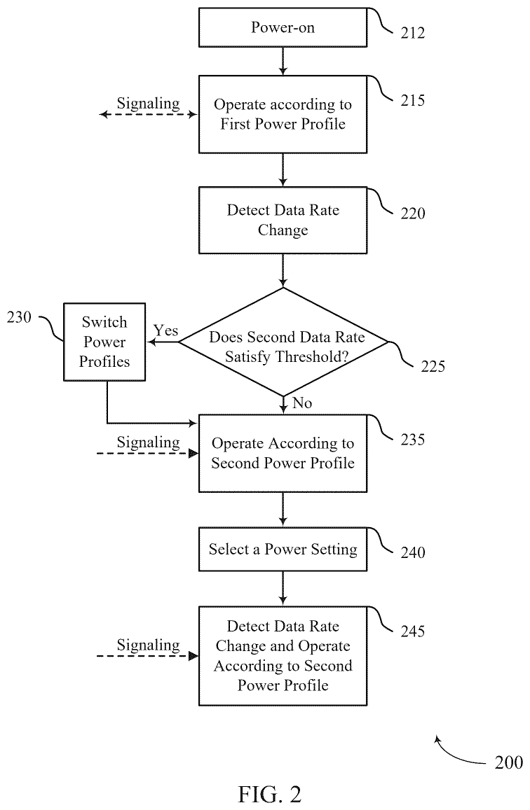

FIG. 2 shows an example of a flow diagram 200 that supports dynamic power profile adjustment in accordance with examples as disclosed herein. In some cases, aspects of the flow diagram 200 may implement or be implemented by aspects of FIG. 1. For example, the flow diagram 200 may illustrate operations performed by a memory system in response to or in accordance with signaling received from a host system, which may be examples of the host system 105 and the memory system 110 as described herein with respect to FIG. 1. In some aspects, the memory system may dynamically adjust a power profile for operations with the host system in response to a data rate change associated with the memory system.

In the following description of the flow diagram 200, the operations may be performed in a different order than the order shown, or other operations may be added or removed from the flow diagram 200. For example, some operations may also be left out of flow diagram 200, may be performed in different orders or at different times, or other operations may be added to flow diagram 200. Although the host system and the memory system are shown performing the operations of the flow diagram 200, some aspects of some operations may also be performed by one or more other systems or devices (e.g., memory devices). Operations that the host system performs in the flow diagram 200 may be implemented in instructions stored on memory of the host system, and may be executed by the host system controller 106. Similarly, the operations that the memory system performs in the flow diagram 200 may be implemented in instructions or firmware stored on memory (e.g., local memory 120, memory device 130-a, memory device 130-b) of the memory system, and may be executed by the memory system controller 115, one or more of the local controllers 135.

Additionally, or alternatively, aspects of the flow diagram 200 may be implemented by one or more controllers, among other components. Additionally, or alternatively, aspects of the flow diagram 200 may be implemented as instructions stored in one or more memories (e.g., firmware stored in one or more memories coupled with the memory system). For example, the instructions, when executed by one or more controllers (e.g., the memory system controller 115, the power profile component 125), may cause the one or more controllers (or a device or a system) to perform the operations of the flow diagram 200.

At 212, the memory system may be powered-on. For example, the memory system may be coupled with the host system, which may power-on the memory system. Additionally, or alternatively, at 212 the memory system may begin an initialization process or period. In some cases, at 212, the memory system may begin one or more operations of a period (e.g., a power-on period, the initialization period), which may include exchanging signaling with the host system. In some cases, one or more of the operations of flow diagram 200 (e.g., operations 215-225) may occur within the period.

At 215, the memory system may operate according to a first power profile (e.g., corresponding to a first operation protocol, such as UFS3) and at a first data rate. For example, the memory system controller 115 may operate the memory system at the first power profile and the first data rate. In some cases, operating the memory system according to the first power profile may include exchange signaling with the host system according to the first power profile and the first data rate. In some cases, the first power profile (e.g., UFS3) may be a default power profile, and the memory system may operate according to the default power profile during the period (e.g., as an initial power profile after power-on or some other initialization event).

In some cases, the first power profile may include or otherwise be associated with a first plurality of clock settings for the operations by the memory system (e.g., processing or exchanging read and write commands, exchanging signaling with the host system). For example, the first power profile may be associated with a table of clock settings, where each row may include a respective clock setting for each clock of one or more clocks of the memory system. Additionally, or alternatively, each clock setting of the first plurality of clock settings may include a table of one or more parameters for one or more clocks of the memory system. For example, different parameters for a clock of the one or more clocks may correspond to different data rates (e.g., gears) used at the memory system. That is, a power profile may include a plurality of clock settings, and each clock setting may include at least one parameter for each clock of the one or more clocks of the memory system. In some cases, operating according to the first power profile may include operating the one or more clocks of the memory system according to respective parameters for each of the one or more clocks from a first clock setting of the first plurality of clock settings. In some cases, the one or more clocks of the memory system may include one or more of a main central processing unit (CPU) clock, a sub-CPU clock, an ONFI clock, or any other type of clock.

Each clock setting of the first power profile may be associated with a power consumption level (e.g., a clock setting associated with faster clock parameters may cause the memory system to consume more power than a clock setting associated with slower clock parameters). Thus, a candidate power setting may be associated with one or more clock settings of the plurality of clock settings associated with a range of power consumption levels.

In some cases, the memory system may select a first clock setting of the first plurality of clock settings to use at the memory system according to one or more operation parameters associated with the memory system. The one or more operation parameters may include one or more of an operating temperature associated with the memory system, an operation requested by the host system, or a degradation level associated with one or more memory devices (e.g., the memory devices 130) of the memory system. For example, the memory system may determine to operate according to a first clock setting corresponding to first settings for each of the clocks of the memory system in response to a temperature of the memory system being above a threshold, or some other condition being satisfied, where the first clock setting is one of multiple candidate clock settings each associated with the default power profile. In such cases, each clock setting within the set of candidate clock settings for a given power profile may be associated with (e.g., configured with, mapped to) a respective condition or set of conditions (e.g., a threshold temperature range, a degradation level, or the like).

At 220, a data rate change may be detected. For example, the power profile component 125, the memory system controller 115, or both, may detect a change from the first data rate to a second data rate for operations by the memory system. In some cases, the second data rate may be greater than the first data rate. The memory system may keep track of (e.g., record) a highest data rate at the memory system since a first time (e.g., a time at which the memory system was powered on) until a second time after the first time (e.g., an end of a power-on duration, an end of an initialization period). In some cases, the second data rate may be the highest recorded data rate at the memory system since powering on the memory device, the highest recorded data rate at the memory system within the period (e.g., power-on duration, initialization period), or both.

At 225, a determination of whether the second data rate satisfies a threshold data rate may be performed. For example, the power profile component 125 may determine whether the second data rate satisfies the threshold data rate in response to the change in data rate (e.g., detecting the change in the data rate). In some cases, the power profile component 125 may compare the second data rate with the threshold data rate to determine whether the second data rate satisfies (e.g., is greater than or equal to) the threshold data rate.

At 230, if it is determined, at 225, that the second data rate satisfies (e.g., is greater than or equal to) the threshold data rate, the power profile may be switched. That is, if the second data rate satisfies the threshold data rate, the first power profile may be switched to a second power profile that is different than the first power profile. The memory system may switch power profiles in response to the second data rate satisfying the threshold data rate. For example, the second power profile may correspond to a second flash protocol (e.g., UFS4) that is different from the first flash protocol. In some cases, the second flash protocol may support data rates that are greater than or equal to the threshold data rate. Thus, in response to the host system selecting a data rate (e.g., a gear) that satisfies the threshold data rate, the memory system may begin to operate according to the second power profile.

At 235, in response to detecting the data rate change at 220 and the determination at 225, the memory system may be operated according to the second data rate and a second power profile, which may include switching the memory system from the first power profile to the second power profile for the operations by the memory system. For example, the memory system controller 115, the power profile component 125, or both, may operate the memory system according to the second data rate and second power profile in response to (e.g., based on) detecting the change in data rate and determining whether the second data rate satisfies the threshold data rate.

If it is determined, at 225, that the second data rate satisfies the threshold data rate, the memory system may be operated according to a second data rate that is different from the first data rate and the second power profile that is different from the first power profile (e.g., in accordance with the switch at 230). If it is determined, at 225, that the second data rate does not satisfy (e.g., is less than) the threshold data rate, the memory system may be operated according to the second power profile that may be the same as the first power profile. That is, the memory system may not switch power profiles if the second data rate does not satisfy the threshold data rate. The memory system may maintain the first power profile to support data rates up to the threshold data rate, which may improve reliability and reduce power consumption, among other examples, as compared with switching to the second power profile for data rates that are less than the threshold data rate.

In some cases, the second power profile may be similar to the first power profile in structure. For example, the second power profile may include a second plurality of clock settings for the operations by the memory system (e.g., exchanging signaling with the host system, performing one or more other memory operations, and the like), where each clock setting of the second plurality of clock settings may include a table of parameters (e.g., clock parameters) for the one or more clocks of the memory system. Operating according to the second power profile may include operating the one or more clocks of the memory system according to respective parameters for the one or more clocks from a second clock setting of the second plurality of clock settings. In some cases, the second power profile may also be associated with a second plurality of candidate power settings for the memory system, as described herein at 215. Additionally, or alternatively, the memory system may determine a second clock setting to use at the memory system according to the one or more operations parameters, as described herein at 215.

At 240, a power setting may be selected to use for the operations by the memory system. For example, the memory system controller 115, the power profile component 125, or both, may select one of a first power setting or a second power setting according to a power consumption of a plurality of power consumptions associated with at least a first power setting and a second power setting.

For example, after switching to the second power profile, the memory system (e.g., the memory system controller 115, the power profile component 125) may determine the first power setting (e.g., from a second plurality of candidate power settings associated with the second power profile). In some cases, the memory system may select the first power setting according to (e.g., to satisfy) the changed data rate (e.g., a second data rate) of the memory system. Additionally, or alternatively, the memory system may select a second power setting of the second plurality of candidate power settings. In some cases, the memory system may select the second power setting according to one or more of the operation parameters associated with the memory system. For example, the memory system may select the second power setting to maintain a threshold operating temperature at the memory system, to perform a requested operation, or to operate at a degradation level associated with a memory device of the memory system. After determining at least the first power setting and the second power setting, the memory system may select either the first power setting or the second power setting according to which of the first power setting and the second power setting are associated with a lower power consumption, a lower data rate, a lower clock parameter, or any combination thereof.

At 245, a data rate change (e.g., a second data rate change) may be detected. For example, the memory system controller 115, the power profile component 125, or both, may detect (e.g., after a duration of operating according to the second power profile, after the period described herein) a change from the second data rate to a third data rate. In some cases, the third data rate may be less than the threshold data rate. In some cases, the memory system may continue to operate according to the second power profile and at the third data rate after the duration in response to the first data rate change. For example, the memory system may continue to operate according to the second power profile even at the third data rate (e.g., a data rate that may be less than the threshold data rate) in response to the second data rate satisfying (e.g., being greater than) the threshold data rate. That is, after switching to operate according to the second power profile in response to the threshold data rate being satisfied, the memory system may continue to operate according to the second power profile irrespective of a data rate associated with the host system and the memory system at least until a subsequent power profile determination event (e.g., power on, power-cycle, initialization).

The memory system may thereby operate in a default (e.g., first) power profile until one or more threshold data rates are satisfied, at which point the memory system may switch power profiles and may not switch back to the default power profile until a subsequent determination event. Thus, a memory system operating according to the techniques described herein may support dynamic power profile adjustment. The memory system may support operations with the host system and one or more other host systems that may support the same or different operation protocols. By configuring the memory system to operate as described herein, a system manufacturer may manufacture a single type of memory system that may be compatible with multiple different types of host systems. Although a single threshold data rate is described with reference to FIG. 2, it is to be understood that the memory system may adjust power profiles in response to any quantity of one or more thresholds in order to dynamically adjust power profiles in accordance with a host system's operating protocols. In some cases, such a memory system may experience increased performance (e.g., higher data speeds, improved reliability) in response to operating according to the techniques described herein.

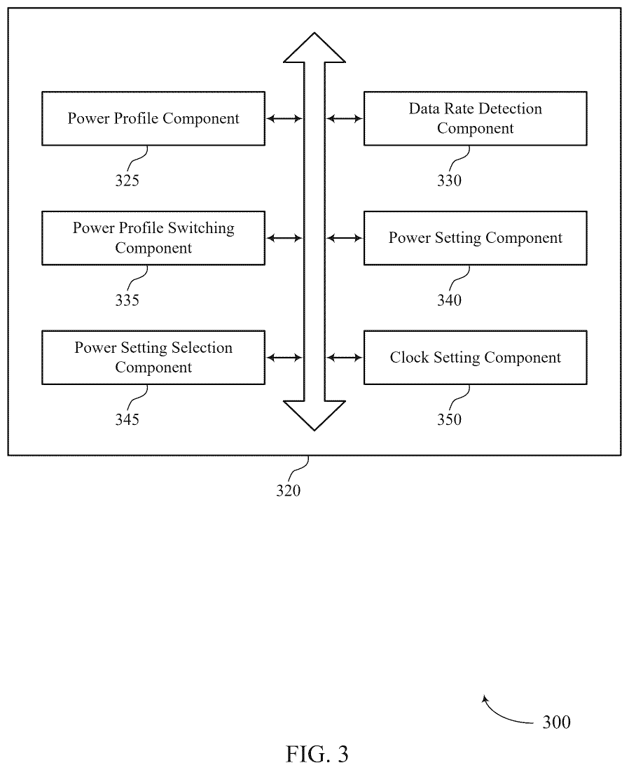

FIG. 3 shows a block diagram 300 of a memory system 320 that supports dynamic power profile adjustment in accordance with examples as disclosed herein. The memory system 320 may be an example of aspects of a memory system as described with reference to FIGS. 1 through 2. The memory system 320, or various components thereof, may be an example of means for performing various aspects of dynamic power profile adjustment as described herein. For example, the memory system 320 may include a power profile component 325, a data rate detection component 330, a power profile switching component 335, a power setting component 340, a power setting selection component 345, a clock setting component 350, or any combination thereof. Each of these components, or components of subcomponents thereof (e.g., one or more processors, one or more memories), may communicate, directly or indirectly, with one another (e.g., via one or more buses).

The power profile component 325 may be configured as or otherwise support a means for operating the memory system according to a first power profile and a first data rate. The data rate detection component 330 may be configured as or otherwise support a means for detecting a change from the first data rate to a second data rate for operations by the memory system, the second data rate greater than the first data rate. In some examples, the data rate detection component 330 may be configured as or otherwise support a means for determining whether the second data rate satisfies a threshold data rate in response to the change. In some examples, the power profile component 325 may be configured as or otherwise support a means for operating the memory system according to the second data rate and a second power profile in accordance with determining whether the second data rate satisfies the threshold data rate.

In some examples, to support operating the memory system according to the second data rate and the second power profile, the power profile component 325 may be configured as or otherwise support a means for operating the memory system according to the second data rate and the second power profile that is different from the first power profile in response to determining that the second data rate is greater than or equal to the threshold data rate.

In some examples, the data rate detection component 330 may be configured as or otherwise support a means for detecting, after a duration, a second change from the second data rate to a third data rate that is less than the threshold data rate. In some examples, the power profile component 325 may be configured as or otherwise support a means for operating, after the duration in response to the second change, the memory system according to the second power profile and at the third data rate, where operating according to the second power profile after the duration is in accordance with the third data rate being less than the threshold data rate.

In some examples, the first power profile includes a first plurality of clock settings for the operations by the memory system, each clock setting of the first plurality of clock settings including first parameters for one or more clocks of the memory system. In some examples, the second power profile includes a second plurality of clock settings for the operations by the memory system, each clock setting of the second plurality of clock settings including second parameters for the one or more clocks of the memory system.

In some examples, to support operating according to the first power profile or the second power profile, the power profile component 325 may be configured as or otherwise support a means for operating the one or more clocks of the memory system according to respective parameters for the one or more clocks in accordance with a first clock setting of the first plurality of clock settings or a second clock setting of the second plurality of clock settings, respectively.

In some examples, the clock setting component 350 may be configured as or otherwise support a means for selecting a first clock setting of the first plurality of clock settings or a second clock setting of the second plurality of clock settings in accordance with one or more operation parameters associated with the memory system, the one or more operation parameters including one or more of an operating temperature associated with the memory system, an operation requested by a host system, or a degradation level associated with one or more memory devices of the memory system.

In some examples, the one or more clocks include one or more of a main CPU clock, a sub-CPU clock, or an ONFI clock.

In some examples, the power profile switching component 335 may be configured as or otherwise support a means for switching from the first power profile to the second power profile for the operations by the memory system in response to detecting the change, where the first power profile is associated with a first plurality of candidate power settings and the second power profile is associated with a second plurality of candidate power settings for the memory system. In some examples, the power setting component 340 may be configured as or otherwise support a means for determining, in response to switching to the second power profile, a first power setting of the second plurality of candidate power settings associated with the second power profile, where the first power setting is in accordance with the second data rate of the memory system. In some examples, the power setting component 340 may be configured as or otherwise support a means for determining, in response to switching to the second power profile, a second power setting of the second plurality of candidate power settings associated with the second power profile, where the second power setting is in accordance with an operation parameter associated with the memory system. In some examples, the power setting selection component 345 may be configured as or otherwise support a means for selecting one of the first power setting or the second power setting to use for the operations by the memory system in accordance with a lowest power consumption of a plurality of power consumptions associated with the first power setting and the second power setting.

In some examples, to support operating the memory system according to the second data rate and the second power profile, the power profile component 325 may be configured as or otherwise support a means for operating the memory system according to the second data rate and the second power profile that is the same as the first power profile in response to determining that the second data rate is less than the threshold data rate.

In some examples, the second data rate includes a highest data rate recorded by the memory system since a first time at which the memory system was powered on.

In some examples, the first power profile corresponds to a first flash protocol and the second power profile corresponds to a second flash protocol that is different from the first flash protocol. In some examples, the second flash protocol supports data rates that are greater than or equal to the threshold data rate.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

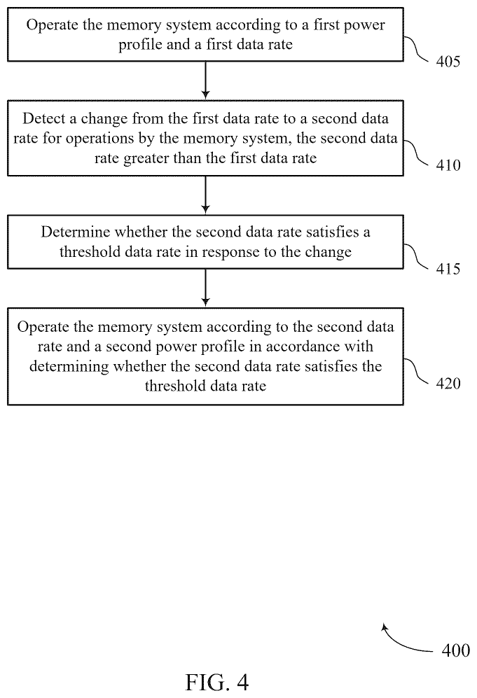

FIG. 4 shows a flowchart illustrating a method 400 that supports dynamic power profile adjustment in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include operating the memory system according to a first power profile and a first data rate. In some examples, aspects of the operations of 405 may be performed by a power profile component 325 as described with reference to FIG. 3.

At 410, the method may include detecting a change from the first data rate to a second data rate for operations by the memory system, the second data rate greater than the first data rate. In some examples, aspects of the operations of 410 may be performed by a data rate detection component 330 as described with reference to FIG. 3.

At 415, the method may include determining whether the second data rate satisfies a threshold data rate in response to the change. In some examples, aspects of the operations of 415 may be performed by a data rate detection component 330 as described with reference to FIG. 3.

At 420, the method may include operating the memory system according to the second data rate and a second power profile in accordance with determining whether the second data rate satisfies the threshold data rate. In some examples, aspects of the operations of 420 may be performed by a power profile component 325 as described with reference to FIG. 3.

In some examples, an apparatus as described herein may perform a method or methods, such as the method 400. The apparatus may include operations, features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating the memory system according to a first power profile and a first data rate; detecting a change from the first data rate to a second data rate for operations by the memory system, the second data rate greater than the first data rate; determining whether the second data rate satisfies a threshold data rate in response to the change; and operating the memory system according to the second data rate and a second power profile in accordance with determining whether the second data rate satisfies the threshold data rate.

Aspect 2: The method, apparatus, or non-transitory computer-readable medium of aspect 1, where operating the memory system according to the second data rate and the second power profile includes operations, features, circuitry, logic, means, or instructions, or any combination thereof for operating the memory system according to the second data rate and the second power profile that is different from the first power profile in response to determining that the second data rate is greater than or equal to the threshold data rate.

Aspect 3: The method, apparatus, or non-transitory computer-readable medium of aspect 2, further including operations, features, circuitry, logic, means, or instructions, or any combination thereof for detecting, after a duration, a second change from the second data rate to a third data rate that is less than the threshold data rate and operating, after the duration in response to the second change, the memory system according to the second power profile and at the third data rate, where operating according to the second power profile after the duration is in accordance with the third data rate being less than the threshold data rate.

Aspect 4: The method, apparatus, or non-transitory computer-readable medium of any of aspects 1 through 3, where the first power profile includes a first plurality of clock settings for the operations by the memory system, each clock setting of the first plurality of clock settings including first parameters for one or more clocks of the memory system and the second power profile includes a second plurality of clock settings for the operations by the memory system, each clock setting of the second plurality of clock settings including second parameters for the one or more clocks of the memory system.

Aspect 5: The method, apparatus, or non-transitory computer-readable medium of aspect 4, where operating according to the first power profile or the second power profile includes operations, features, circuitry, logic, means, or instructions, or any combination thereof for operating the one or more clocks of the memory system according to respective parameters for the one or more clocks in accordance with a first clock setting of the first plurality of clock settings or a second clock setting of the second plurality of clock settings, respectively.

Aspect 6: The method, apparatus, or non-transitory computer-readable medium of any of aspects 4 through 5, further including operations, features, circuitry, logic, means, or instructions, or any combination thereof for selecting a first clock setting of the first plurality of clock settings or a second clock setting of the second plurality of clock settings in accordance with one or more operation parameters associated with the memory system, the one or more operation parameters including one or more of an operating temperature associated with the memory system, an operation requested by a host system, or a degradation level associated with one or more memory devices of the memory system.

Aspect 7: The method, apparatus, or non-transitory computer-readable medium of any of aspects 4 through 6, where the one or more clocks include one or more of a main CPU clock, a sub-CPU clock, or an ONFI clock.

Aspect 8: The method, apparatus, or non-transitory computer-readable medium of any of aspects 1 through 7, further including operations, features, circuitry, logic, means, or instructions, or any combination thereof for switching from the first power profile to the second power profile for the operations by the memory system in response to detecting the change, where the first power profile is associated with a first plurality of candidate power settings and the second power profile is associated with a second plurality of candidate power settings for the memory system; determining, in response to switching to the second power profile, a first power setting of the second plurality of candidate power settings associated with the second power profile, where the first power setting is in accordance with the second data rate of the memory system; determining, in response to switching to the second power profile, a second power setting of the second plurality of candidate power settings associated with the second power profile, where the second power setting is in accordance with an operation parameter associated with the memory system; and selecting one of the first power setting or the second power setting to use for the operations by the memory system in accordance with a lowest power consumption of a plurality of power consumptions associated with the first power setting and the second power setting.

Aspect 9: The method, apparatus, or non-transitory computer-readable medium of aspect 1, where operating the memory system according to the second data rate and the second power profile includes operations, features, circuitry, logic, means, or instructions, or any combination thereof for operating the memory system according to the second data rate and the second power profile that is the same as the first power profile in response to determining that the second data rate is less than the threshold data rate.

Aspect 10: The method, apparatus, or non-transitory computer-readable medium of any of aspects 1 through 9, where the second data rate includes a highest data rate recorded by the memory system since a first time at which the memory system was powered on.

Aspect 11: The method, apparatus, or non-transitory computer-readable medium of any of aspects 1 through 10, where the first power profile corresponds to a first flash protocol and the second power profile corresponds to a second flash protocol that is different from the first flash protocol and the second flash protocol supports data rates that are greater than or equal to the threshold data rate.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in response to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories; and
one or more processors coupled with the one or more memories and individually or collectively operable to cause the apparatus to:
operate a memory system according to a first power profile and a first data rate;
detect a change from the first data rate to a second data rate for operations by the memory system, the second data rate greater than the first data rate;
determine whether the second data rate satisfies a threshold data rate in response to the change; and
operate the memory system according to the second data rate and a second power profile in accordance with determining whether the second data rate satisfies the threshold data rate.

2. The apparatus of claim 1, wherein, to operate the memory system according to the second data rate and the second power profile, the one or more processors are individually or collectively operable to cause the apparatus to:
operate the memory system according to the second data rate and the second power profile that is different from the first power profile in response to determining that the second data rate is greater than or equal to the threshold data rate.

3. The apparatus of claim 2, wherein the one or more processors are individually or collectively further operable to cause the apparatus to:
detect, after a duration, a second change from the second data rate to a third data rate that is less than the threshold data rate; and
operate, after the duration in response to the second change, the memory system according to the second power profile and at the third data rate, wherein operating according to the second power profile after the duration is in accordance with the third data rate being less than the threshold data rate.

4. The apparatus of claim 1, wherein:
the first power profile comprises a first plurality of clock settings for the operations by the memory system, each clock setting of the first plurality of clock settings comprising first parameters for one or more clocks of the memory system; and
the second power profile comprises a second plurality of clock settings for the operations by the memory system, each clock setting of the second plurality of clock settings comprising second parameters for the one or more clocks of the memory system.

5. The apparatus of claim 4, wherein, to operate according to the first power profile or the second power profile, the one or more processors are individually or collectively operable to cause the apparatus to:
operate the one or more clocks of the memory system according to respective parameters for the one or more clocks in accordance with a first clock setting of the first plurality of clock settings or a second clock setting of the second plurality of clock settings, respectively.

6. The apparatus of claim 4, wherein the one or more processors are individually or collectively further operable to cause the apparatus to:
select a first clock setting of the first plurality of clock settings or a second clock setting of the second plurality of clock settings in accordance with one or more operation parameters associated with the memory system, the one or more operation parameters comprising one or more of an operating temperature associated with the memory system, an operation requested by a host system, or a degradation level associated with one or more memory devices of the memory system.

7. The apparatus of claim 4, wherein the one or more clocks comprise one or more of a main central processing unit (CPU) clock, a sub-CPU clock, or an open non-AND (NAND) flash interface (ONFI) clock.

8. The apparatus of claim 1, wherein the one or more processors are individually or collectively further operable to cause the apparatus to:
switch from the first power profile to the second power profile for the operations by the memory system in response to detecting the change, wherein the first power profile is associated with a first plurality of candidate power settings and the second power profile is associated with a second plurality of candidate power settings for the memory system;
determine, in response to switching to the second power profile, a first power setting of the second plurality of candidate power settings associated with the second power profile, wherein the first power setting is in accordance with the second data rate of the memory system;
determine, in response to switching to the second power profile, a second power setting of the second plurality of candidate power settings associated with the second power profile, wherein the second power setting is in accordance with an operation parameter associated with the memory system; and
select one of the first power setting or the second power setting to use for the operations by the memory system in accordance with a lowest power consumption of a plurality of power consumptions associated with the first power setting and the second power setting.

9. The apparatus of claim 1, wherein, to operate the memory system according to the second data rate and the second power profile, the one or more processors are individually or collectively operable to cause the apparatus to:
operate the memory system according to the second data rate and the second power profile that is the same as the first power profile in response to determining that the second data rate is less than the threshold data rate.

10. The apparatus of claim 1, wherein the second data rate comprises a highest data rate recorded by the memory system since a first time at which the memory system was powered on.

11. The apparatus of claim 1, wherein:
the first power profile corresponds to a first flash protocol and the second power profile corresponds to a second flash protocol that is different from the first flash protocol; and
the second flash protocol supports data rates that are greater than or equal to the threshold data rate.

12. A non-transitory computer-readable medium storing code, the code comprising instructions executable by one or more processors to:
operate a memory system according to a first power profile and a first data rate;
detect a change from the first data rate to a second data rate for operations by the memory system, the second data rate greater than the first data rate;
determine whether the second data rate satisfies a threshold data rate in response to the change; and
operate the memory system according to the second data rate and a second power profile in accordance with determining whether the second data rate satisfies the threshold data rate.

13. The non-transitory computer-readable medium of claim 12, wherein the instructions to operate the memory system according to the second data rate and the second power profile are executable by the one or more processors to:
operate the memory system according to the second data rate and the second power profile that is different from the first power profile in response to determining that the second data rate is greater than or equal to the threshold data rate.

14. The non-transitory computer-readable medium of claim 13, wherein the instructions are further executable by the one or more processors to:
detect, after a duration, a second change from the second data rate to a third data rate that is less than the threshold data rate; and
operate, after the duration in response to the second change, the memory system according to the second power profile and at the third data rate, wherein operating according to the second power profile after the duration is in accordance with the third data rate being less than the threshold data rate.

15. The non-transitory computer-readable medium of claim 12, wherein:
the first power profile comprises a first plurality of clock settings for the operations by the memory system, each clock setting of the first plurality of clock settings comprising first parameters for one or more clocks of the memory system; and
the second power profile comprises a second plurality of clock settings for the operations by the memory system, each clock setting of the second plurality of clock settings comprising second parameters for the one or more clocks of the memory system.

16. The non-transitory computer-readable medium of claim 15, wherein the instructions to operate according to the first power profile or the second power profile are executable by the one or more processors to:
operate the one or more clocks of the memory system according to respective parameters for the one or more clocks in accordance with a first clock setting of the first plurality of clock settings or a second clock setting of the second plurality of clock settings, respectively.

17. The non-transitory computer-readable medium of claim 15, wherein the instructions are further executable by the one or more processors to:
select a first clock setting of the first plurality of clock settings or a second clock setting of the second plurality of clock settings in accordance with at one or more operation parameters associated with the memory system, the one or more operation parameters comprising one or more of an operating temperature associated with the memory system, an operation requested by a host system, or a degradation level associated with one or more memory devices of the memory system.

18. The non-transitory computer-readable medium of claim 15, wherein the one or more clocks comprise one or more of a main central processing unit (CPU) clock, a sub-CPU clock, or an open non-AND (NAND) flash interface (ONFI) clock.

19. The non-transitory computer-readable medium of claim 12, wherein the instructions are further executable by the one or more processors to:
switch from the first power profile to the second power profile for the operations by the memory system in response to detecting the change, wherein the first power profile is associated with a first plurality of candidate power settings and the second power profile is associated with a second plurality of candidate power settings for the memory system;
determine, in response to switching to the second power profile, a first power setting of the second plurality of candidate power settings associated with the second power profile, wherein the first power setting is in accordance with the second data rate of the memory system;
determine, in response to switching to the second power profile, a second power setting of the second plurality of candidate power settings associated with the second power profile, wherein the second power setting is in accordance with an operation parameter associated with the memory system; and
select one of the first power setting or the second power setting to use for the operations by the memory system in accordance with a lowest power consumption of a plurality of power consumptions associated with the first power setting and the second power setting.

20. The non-transitory computer-readable medium of claim 12, wherein the instructions to operate the memory system according to the second data rate and the second power profile are executable by the one or more processors to:
operate the memory system according to the second data rate and the second power profile that is the same as the first power profile in response to determining that the second data rate is less than the threshold data rate.

21. The non-transitory computer-readable medium of claim 12, wherein the second data rate comprises a highest data rate recorded by the memory system since a first time at which the memory system was powered on.

22. The non-transitory computer-readable medium of claim 12, wherein:
the first power profile corresponds to a first flash protocol and the second power profile corresponds to a second flash protocol that is different from the first flash protocol; and
the second flash protocol supports data rates that are greater than or equal to the threshold data rate.

23. A method for operating a memory system, comprising:
operating the memory system according to a first power profile and a first data rate;
detecting a change from the first data rate to a second data rate for operations by the memory system, the second data rate greater than the first data rate;
determining whether the second data rate satisfies a threshold data rate in response to the change; and
operating the memory system according to the second data rate and a second power profile in response to determining whether the second data rate satisfies the threshold data rate.
